(19) United States
(12) Patent Application Publication
(10) Pub. No.: US 2011/0048846 A1
(43) Pub. Date: Mar. 3, 2011

(54) Noise attenuator for a hydraulic fluid pipe, item comprising this attenuator, pipe comprising this item and method of assembly

(75) Inventors: Eric Bonneau, Saint Romain de Jalionas (FR); Eric Nowak, Nogent Sur Marne (FR); Regis Chaon, Noidant le Rocheux (FR)

(73) Assignee: Compagnie Plastic Omnium, Lyon (FR)

(21) Appl. No.: 12/309,233

(22) PCT Filed: Jul. 13, 2007
(86) PCT No.: PCT/FR2007/051662

§ 371 Date: Sep. 21, 2009

(30) Foreign Application Priority Data
Jul. 13, 2006 (FR) 0652982

(51) Int. Cl. G10K 11/16; B23P 19/00

(52) U.S. Cl. 181/211; 181/233; 29/428

(57) ABSTRACT

This noise attenuator for a hydraulic fluid pipe is made of a material porous to the fluid intended to flow through the noise attenuator. More specifically, the material is a synthetic material. As a preference, the synthetic material is porous polytetrafluoroethylene.

Noise attenuator for hydraulic fluid pipe, item comprising this attenuator, pipe comprising this item and method of assembly.

This invention concerns a noise attenuator for hydraulic fluid pipe, an item comprising this attenuator, a pipe comprising this item and a method of assembly.

It applies more particularly to a noise attenuator for hydraulic pipe of an automotive vehicle.

For example, the pipe is connected to an oil pump of an automatic transmission in the automotive vehicle, this pump supplying the hydraulic pressure required to change gear.

We know that the pump vibrations and the oil pressure variations generate an operating noise in the pipe which can be transmitted into the passenger compartment of the automotive vehicle.

It is known that this phenomenon can be limited by manufacturing the pipe from two tubes: an external fluid-tight tube and an internal tube in which the pressurised oil flows while being able to infiltrate the tubular space between the two tubes.

The internal tube, known as the attenuator, may consist of a hose made from a synthetic or metallic material, comprising small holes allowing the fluid to flow in the attenuator.

According to another known embodiment, the noise attenuator is made from a metallic material and comprises two superimposed helicoidal windings, between which the hydraulic fluid can infiltrate.

In these two known forms, the noise attenuator is therefore relatively difficult to manufacture.

The main purpose of the invention is to propose a noise attenuator which is easier to manufacture.

The invention therefore relates to a noise attenuator for hydraulic fluid pipe, characterised in that it is made from a material porous to the fluid intended to flow in the noise attenuator.

In this description, porous to a fluid refers to a material whose structure has natural interstices between its molecules allowing the fluid to flow.

Consequently, the fluid flowing in the attenuator according to the invention infiltrates the structure of the porous material through the natural interstices.

There is therefore no need to make holes or use a metallic helicoidal winding.

Preferably, to avoid corrosion risks, the porous material is a synthetic porous material. Preferably, the relative density of the material is between 1.5 and 2.15. For example, the synthetic material is porous polytetrafluoroethylene (PTFE).

The noise attenuator is generally connected directly to a discharge nozzle of a hydraulic pump, in order to attenuate the operating noise.

The invention therefore also relates to an item comprising a noise attenuator as described above, characterised in that it comprises a unit for connection to a nozzle having a portion whose cross-section tapers in the direction going from the attenuator to the nozzle, the unit having an adapter connected to the noise attenuator and a radial expansion bell intended to be clipped onto the portion of the nozzle with tapering cross-section.

Preferably, the radial expansion bell comprises a tubular skirt with axial slots on the end to facilitate its elastic radial expansion.

An item according to the invention may also include one or more of the characteristics according to which:
the connection unit comprises an outer surface designed for insertion into a hose and, on this outer surface, means to hold the hose axially;
the nozzle having an internal cross-section for the fluid to flow, the connection unit comprises a cross-section adaptation channel having a cross-section progressively varying from the cross-section where fluid flows in the adapter to the cross-section where fluid flows in the radial expansion bell;
the adapter is ribbed for its connection to the noise attenuator.

The invention also relates to a hydraulic fluid pipe comprising an item as described above and a hose, the pipe being designed for connection to a nozzle having a portion whose cross-section tapers in the direction going from the attenuator to the nozzle, this connection being obtained by clipping the radial expansion bell on the portion of the nozzle with tapering cross-section.

A pipe according to the invention may also include an outer socket for blocking the hose on the nozzle, it being possible to crimp the outer socket around the hose.

The invention also relates to a method for assembling a hydraulic fluid pipe as described above to a nozzle having a portion whose cross-section tapers in the direction going from the attenuator to the nozzle, characterised in that it comprises the following steps:
the connection unit of the item is connected to the nozzle by clipping the radial expansion bell on the portion of the nozzle with tapering cross-section,
the hose is pushed onto the item and the nozzle.

A method for assembly according to the invention may also comprise a step for blocking the hose on the nozzle by crimping an outer socket around the hose.

It will be easier to understand the invention on reading the description below, given as an example and referring to the drawings, on which:

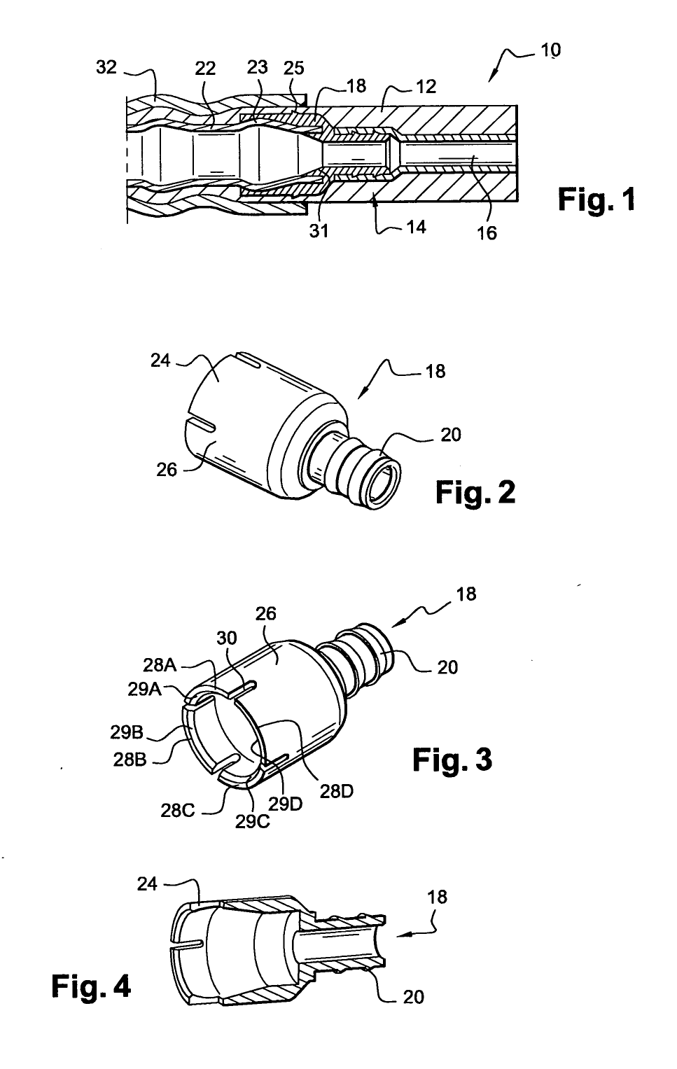

FIG. 1 is a cross-section of a hydraulic fluid pipe for automotive vehicle according to the invention;

FIGS. 2 and 3 are perspective views of a connection unit according to the invention;

FIG. 4 is a cross-section of the connection unit shown on FIGS. 2 and 3.

FIG. 1 represents a hydraulic fluid pipe for automotive vehicle. The pipe is designated by the general reference 10.

Pipe 10 comprises a hose 12 made from elastomer material, for example rubber.

Pipe 10 also comprises an item 14 including a noise attenuator 16 and a connection unit 18.

In this example, the noise attenuator 16 consists of a flexible tubular element made from material porous to the hydraulic fluid intended to flow in the pipe. The porous material is, for example, porous polytetrafluoroethylene (PTFE). Porous to hydraulic fluid refers to a material whose structure has natural interstices between its molecules allowing the fluid to infiltrate.

The porous material of the noise attenuator 16 is characterised, in particular, by its relative density. Experimental tests have demonstrated that this physical quantity is closely linked to the porous properties of the material, in particular its permeability but also the number and size of its pores.

These tests also demonstrated that the relative density of the porous material must preferably be between 1.5 and 2.15, in order to obtain a noise attenuator with optimum rigidity and porosity properties for its application as noise attenuator.

The flexibility of a noise attenuator made from a porous material having a relatively low relative density, for example less than 1.5, is relatively high. Due to this high flexibility, the attenuator is likely to deform under pressure. Such deformations may, in particular, create a frequency shift of the attenuator noise attenuation frequencies.

In addition, the porosity properties of a noise attenuator made from a porous material having a relatively high relative density, for example greater than 2.15, are close to those of a traditional noise attenuator made from a non-porous material. With a relative density greater than 2.15, due to this relatively low porosity, the noise attenuator is no longer efficient enough in terms of noise attenuation.

If the relative density values of the porous material lie between 1.5 and 2.15, however, the noise attenuator exhibits optimum rigidity and porosity properties.

Possibly, in order to improve the attenuation of the noise amplitude at a predetermined frequency, the attenuator may also include holes made in the tubular element. The dimensions, shapes and positions of these holes on the tubular element are chosen so as to allow attenuation of the noise amplitude at this predetermined frequency.

The connection unit 18 is connected to the noise attenuator 16 by a splined adapter 20 which is inserted in the internal channel of the noise attenuator 16. FIG. 1 shows that this insertion causes the noise attenuator to expand, such that the cross-section of the internal channel of the noise attenuator corresponds substantially to that of the internal channel of the adapter.

Pipe 10 is designed to be connected to a nozzle 22. In this example, the nozzle 22 is rigid and is made, for example, from an alloy composed mainly of steel. For example, the rigid nozzle 22 is a discharge outlet for the hydraulic fluid from a hydraulic pump (not shown) of the automotive vehicle.

Nozzle 22 includes a portion 23 whose cross-section tapers in the direction going from the attenuator to the nozzle.

The connection unit 18 comprises, in the alignment of the adapter 20, a radial expansion bell 24 designed to be clipped on the portion 23 of the rigid nozzle with tapering cross-section.

The radial expansion bell 24 comprises a tubular skirt split at its end by axial slots 30 such that the tubular skirt 26 is elastically expandable. In the example described, the tubular skirt 26 is divided into four portions 28A, 28B, 28C, 28D.

The inside of the bell 24 confines a volume complementary to the outer volume of portion 23 of the nozzle with, in particular, an internal additional thickness 29A, 29B, 29C, 29D at each end of portions 28A, 28B, 28C, 28D, this additional thickness being designed to fit the tapering cross-section of the nozzle.

Optionally, to allow a regular flow of hydraulic fluid between the rigid nozzle 22 and the noise attenuator 16, the connection unit 18 comprises, between the radial expansion bell 24 and the adapter 20, a cross-section adaptation channel 31 (represented only on the cross-section of FIG. 1) having a cross-section progressively varying from the cross-section where fluid flows in the adapter 20 to the cross-section where fluid flows in the radial expansion bell 24. In other words, in the example described, the cross-section of the adaptation channel 31 decreases continuously from the internal cross-section of the nozzle 22 to the internal cross-section of the adapter 20.

To block the hose 12 around the rigid nozzle 22, the radial expansion bell 24 may comprise, on its outside, at least one projecting element 25 forming means to hold the hose axially.

To block the hose 12 on the nozzle 22, the pipe 10 comprises an outer socket 32 for blocking the hose 12, the outer socket 32 being attached for example by crimping around the hose 12 and the nozzle.

The main steps of a method for assembling a hydraulic fluid pipe 10 and a rigid nozzle 22 will now be described.

We start from item 14 composed of the connection unit 18 connected by its adapter 20 to the noise attenuator 16.

Firstly, the connection unit 18 is connected to the nozzle 22 by clipping the radial expansion belt 24 on the portion 23 of the nozzle 22.

Secondly, the hose 12 is pushed onto the item 14 and the rigid nozzle 22 connected together.

Due to the projecting element 25 on the radial expansion bell 24, the hose 12 is held axially around item 20 and the rigid nozzle 22. Inversely, the hose 12 prevents radial expansion of the bell 24.

If necessary, the hose 12 is blocked on the nozzle 22 by crimping an outer socket 32 around the hose 12.

We see that, due to the connection unit 18, connection of the pipe 10 on the pump nozzle 22 is simplified, since at most only one crimping operation is required.

Obviously, the embodiment which has just been described must not be construed as limiting.

1. Noise attenuator for hydraulic fluid pipe, the attenuator being made from a material porous to the fluid intended to flow through the noise attenuator.

2. Noise attenuator according to claim 1, wherein the porous material has a relative density between 1.5 and 2.15.

3. Noise attenuator according to claim 1, wherein the material is a synthetic material.

4. Noise attenuator according to claim 3, wherein the synthetic material is porous polytetrafluoroethylene (PTFE).

5. Item comprising a noise attenuator according to claim 1, and comprising wherein a unit for connection to a nozzle having a portion whose cross-section tapers in the direction going from the attenuator to the nozzle, the unit having an adapter connected to the noise attenuator and a radial expansion bell intended to be clipped onto the portion of the nozzle with tapering cross-section.

6. Item according to claim 5, wherein the radial expansion bell includes a tubular skirt with axial slots on the end to facilitate its elastic radial expansion.

7. Item according to claim 5, wherein the connection unit comprises an outer surface designed for insertion into a hose and, on this outer surface, means to hold the hose axially.

8. Item according to claim 5, the nozzle having an internal cross-section for the fluid to flow, wherein the connection unit comprises a cross-section adaptation channel having a cross-section progressively varying from the cross-section where fluid flows in the adapter to the cross-section where fluid flows in the radial expansion bell.

9. Item according to claim 5, wherein the adapter is ribbed for its connection to the noise attenuator.

10. Hydraulic fluid pipe comprising an item according to claim 5 and a hose, the pipe being designed for connection to a nozzle having a portion whose cross-section tapers in the direction going from the attenuator to the nozzle, this connection being obtained by clipping the radial expansion bell on the portion of the nozzle with tapering cross-section.

11. Pipe according to claim 10, comprising an outer socket for blocking the hose on the nozzle, it being possible to crimp the outer socket around the hose.

12. Method for assembling a hydraulic fluid pipe according to claim 10 to a nozzle having a portion whose cross-section tapers in the direction going from the attenuator to the nozzle, comprising the following steps:
the connection unit of item is connected to the nozzle by clipping the radial expansion bell on the portion of the nozzle with tapering cross-section,
the hose is pushed onto the item and the nozzle.

13. Method for assembly according to claim 12, also comprising a step for blocking the hose on the nozzle by crimping an outer socket around the hose.
